(19) United States
(12) Patent Application Publication
(10) Pub. No.: US 2014/0365990 A1
(43) Pub. Date: Dec. 11, 2014

(54) SOFTWARE EVALUATION DEVICE AND METHOD

(71) Applicant: Hitachi, Ltd., Tokyo (JP)

(72) Inventors: SANAE NAKAO, Tokyo (JP); Tomohiko Shigeoka, Tokyo (JP)

(73) Assignee: Hitachi, Ltd., Tokyo (JP)

(21) Appl. No.: 14/300,812

(22) Filed: Jun. 10, 2014

(30) Foreign Application Priority Data
Jun. 11, 2013 (JP) 2013-122647

(51) Int. Cl. G06F 9/44

(52) U.S. Cl. CPC G06F 8/70
USPC 717/101

(57) ABSTRACT

A software evaluation device evaluates quality/performance of software in an early (during) development stage, connected to a development information database having metrics registered corresponding to a revision under development and the revision developed in the past and an I/O unit. The device includes a fluctuation pattern calculation section for calculating fluctuation amount of the metrics of the revisions from the preceding revision as the fluctuation pattern, a similarity calculation section for calculating similarity of the fluctuation pattern between the past developed revision and the revision under development, an evaluation prediction section for selecting the revision with high similarity from the past developed revision, and generating an evaluation prediction model using metrics of the selected revision to calculate an evaluation prediction value of the software from the generated evaluation prediction model and the metrics of the revision under development, and a result output section for displaying the calculated evaluation prediction value on the I/O unit.

### CLAIM OF PRIORITY

The present application claims priority from Japanese patent application JP 2013-122647 filed on Jun. 11, 2013, the content of which is hereby incorporated by reference into this application.

### BACKGROUND OF THE INVENTION

### Field of the Invention

The invention relates to techniques of evaluating software under development.

Today, description amount of embedded software which runs on the embedded processor as a main component of an embedded system has been over-enlarged owing to multi-functionalized embedded system with high functionality. Especially derivative development or maintenance development for adding functionality to or correcting failure of the existing product is highly likely to increase the size and complexity of the embedded software. In the development site, it is essential to ensure quality and performance of the software as a whole, thus demanding quality evaluation and performance evaluation. In the case where the problem owing to quality and performance is discovered in the later development stage, the resultant rework may further increase the development cost. It is therefore effective to conduct evaluation in the development stage as early as possible.

There may be the case that software quality is evaluated based on the predicted number of latent defects and predicted man-hours for development or test of the software. JP-A-2003-140929 discloses techniques of predicting the number of latent defects, describing “software reliability prediction method, software reliability prediction program, computer readable recording medium which records the prediction program, and software reliability prediction device, which allow accurate planning of the test process by estimating the upper limit of the estimated value of the number of potential bugs which exit in the software, and estimating the resultant test period to be relatively loner.” As the technique of predicting the development man-hour, COCOMOII (for example, see Barry Boehm et al. “Software Cost Estimation with Cocomo II”, Prentice Hall, 2000) is known. The COCOMOII provides the model for man-hour prediction in the development using the existing source code.

JP-A-2011-181034 discloses the performance evaluation technique, describing that “the system for evaluating effective performance of software is configured to allow the execution environment information acquisition section to acquire execution environment information representing specification and performance of the software execution environment. The execution environment information storage section stores the execution environment information. The program analysis section analyzes nests of the software program code and the respective performances of the nests. The analytical result storage section stores information on the nest performance analyzed by the analysis section. The selection section selects the nest for evaluating the performance from the nest contained in the program code. The performance acquisition section acquires the value representing the software effective performance based on the execution environment information and the nest performance information concerning the nest selected by the selection section”.

### BRIEF SUMMARY OF THE INVENTION

JP-A-2003-140929 is configured that the number of latent defects cannot be estimated until entry into the test process, that is, in the software development process. Literature of Barry Boehm et al. discloses the provision of the model as a base for the use of the existing source code. However, the fluctuation factor from the base has to be calculated for the respective organizations or projects, thus generating additional man-hours for analyzing the fluctuation factor.

Generally, influence on the performance of the software as a whole may vary dependent on the part subjected to correction or addition. JP-A-2011-181034 is configured to evaluate the effective performance of the software based on the execution environment information and the nest performance information without considering the corrected or added part. It is also configured to evaluate the performance only after implementation of the source code.

As described above, it is difficult to evaluate quality and performance of the software in the derivative development or maintenance development for adding the functionality or correcting the failure of the existing product in the development stage, for example, the timing before or during implementation of the source code.

For that reason, the device and method of evaluating software quality and performance have been required in the earlier stage of (during) the derivative development or maintenance development.

The software evaluation device for evaluating software under development is connected to a development information database that registers software metrics and process metrics corresponding to a revision under development of the software and a revision developed in the past, and an I/O unit. The device includes a fluctuation pattern calculation section which calculates an amount of fluctuation of at least one of the software metrics and the process metrics of the revision under development of the software and a revision developed in the past from the revision prior to the respective revisions as a fluctuation pattern, a similarity calculation section which calculates similarity of the fluctuation pattern between the revision of the software developed in the past and the revision under development of the software, an evaluation prediction section which selects the revision with the high similarity among those of the software developed in the past, and generates an evaluation prediction model for predicting an evaluation prediction value of the software by using the software metrics and the process metrics of the selected revision to calculate the evaluation prediction value of the software from the generated evaluation prediction model, and at least one of the software metrics and the process metrics of the revision of the software under development, and a result output section which displays the calculated evaluation prediction value on the I/O unit.

According to the present invention, the software quality and performance may be evaluated in the earlier development stage.

### BRIEF DESCRIPTION OF THE DRAWINGS

FIG. 1 is a view showing an example of a structure of a software evaluation device according to a first embodiment;

FIG. 2 is a view showing an example of a software metrics table according to the first embodiment;

FIG. 3 is a view showing an example of a process metrics table;

FIG. 4 shows an example of a performance evaluation table;

FIG. 5 is a view illustrating an example of a display screen displaying an output performed by a result output section according to the first embodiment;

FIG. 6 is a flowchart representing an example of a process performed by an evaluation process execution section according to the first embodiment;

FIG. 7 is a flowchart representing an example of a process performed by a metrics registration section according to the first embodiment;

FIG. 8 is a flowchart representing an example of a process performed by a fluctuation pattern calculation section according to the first embodiment;

FIG. 9 is a flowchart representing an example of a process performed by a similarity calculation section according to the first embodiment;

FIG. 10 is a flowchart representing an example of a process performed by an evaluation prediction section according to the first embodiment;

FIG. 11 is a view showing an example of a structure of a software evaluation device according to a second embodiment;

FIG. 12 is a flowchart representing an example of a process (first half) performed by the fluctuation pattern calculation section according to the second embodiment;

FIG. 13 is a flowchart representing an example of the process (latter half) performed by the fluctuation pattern calculation section according to the second embodiment;

FIG. 14 is a flowchart representing an example of the process performed by the evaluation prediction section according to the second embodiment;

FIG. 15 is a view showing an example of a software evaluation device according to a third embodiment;

FIG. 16 is a view showing an example of a software metrics table according to the third embodiment;

FIG. 17 is a view showing an example of a quality evaluation table;

FIG. 18 is a flowchart representing an example of a process performed by a metrics registration section according to the third embodiment;

FIG. 19 is a flowchart representing an example of the process (latter half) performed by the fluctuation pattern calculation section according to the third embodiment;

FIG. 20 is a flowchart representing an example of a process performed by a similarity calculation section according to the third embodiment;

FIG. 21 is a flowchart representing an example of the process performed by the evaluation prediction section according to the third embodiment;

FIG. 22 is a view showing an example of a structure of a software evaluation device according to a fourth embodiment;

FIG. 23 is a flowchart representing an example of the process (first half) performed by the evaluation prediction section according to the fourth embodiment;

FIG. 24 is a flowchart representing an example of the process (latter half) performed by the evaluation prediction section according to the fourth embodiment;

FIG. 25 is a view illustrating an example of a display screen displaying an output performed by a result output section according to the fourth embodiment; and

FIG. 26 is a view illustrating an example of a computer structure for realizing the software evaluation device according to the respective embodiments.

### DETAILED DESCRIPTION OF THE INVENTION

Embodiments will be described referring to the drawings hereinafter.

### First Embodiment

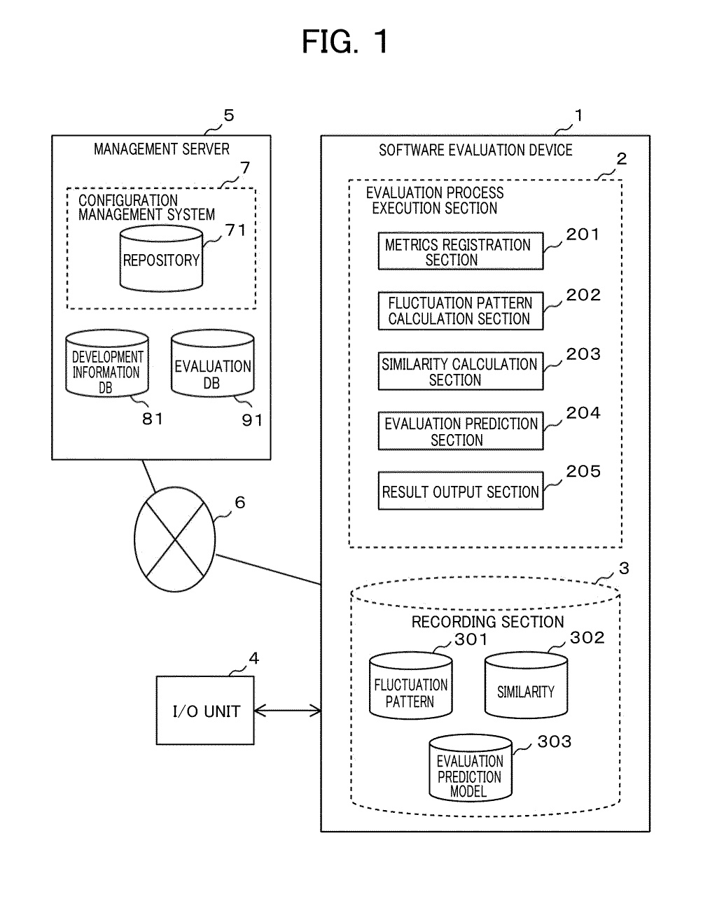

FIG. 1 shows an exemplary structure of a software evaluation device for executing a software evaluation program according to this embodiment. The software evaluation device 1 shown in FIG. 1 is a computer or a dedicated hardware, which includes an evaluation process execution section 2 and a recording section 3, and is connected to an I/O unit 4. The software evaluation device 1 is also connected to a management server 5 via a network 6. The network 6 may employ an existing public network, LAN, WAN and the like, which may be of either wire or wireless type. The software evaluation device 1 calculates a prediction value of a specific evaluation item of the designated revision of the software under development. The embodiment may be configured to designate not only the revision but also release and version.

The management server 5 includes a configuration management system 7 which manages source codes of the software under development, a development information database 81 which stores software development information, and an evaluation database 91 which stores software evaluation results. The configuration management system 7 includes a repository 71 as OSS (Open Source Software) called Subversion, for example. The development information database 81 includes a software metrics table that stores software metrics, and a process metrics table that stores process metrics. The evaluation database 91 includes a performance evaluation table.

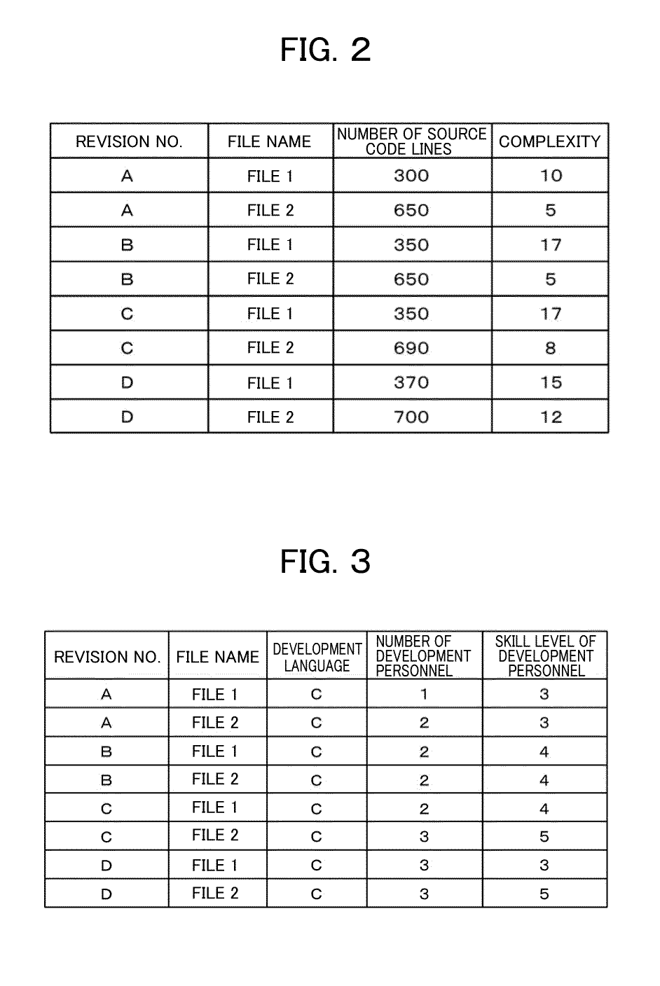

FIG. 2 is a view showing the software metrics table which registers revision numbers of source codes of the respective revisions stored in the repository 71, file names, the number of source code lines of the file, and complexity of the source code of the file. It is possible to use the number of call relationships, the number of classes, the number of properties, the number of function lines, the number of code clones and the like as the software metrics to be registered without limitation to the number of the source code lines of the respective files and the complexity. It is also possible to calculate the statistic values such as the number of source codes lines for each file with respect to those of the software under development as a whole so that the calculated value is used as the software metrics.

FIG. 3 is a view showing the process metrics table which registers revision numbers, file names, development language of file, the number of file development personnel, and skill level of the file development personnel. Besides the development language, the number and skill level of development personnel, is possible to use the number of development sites, and name and version of OS.

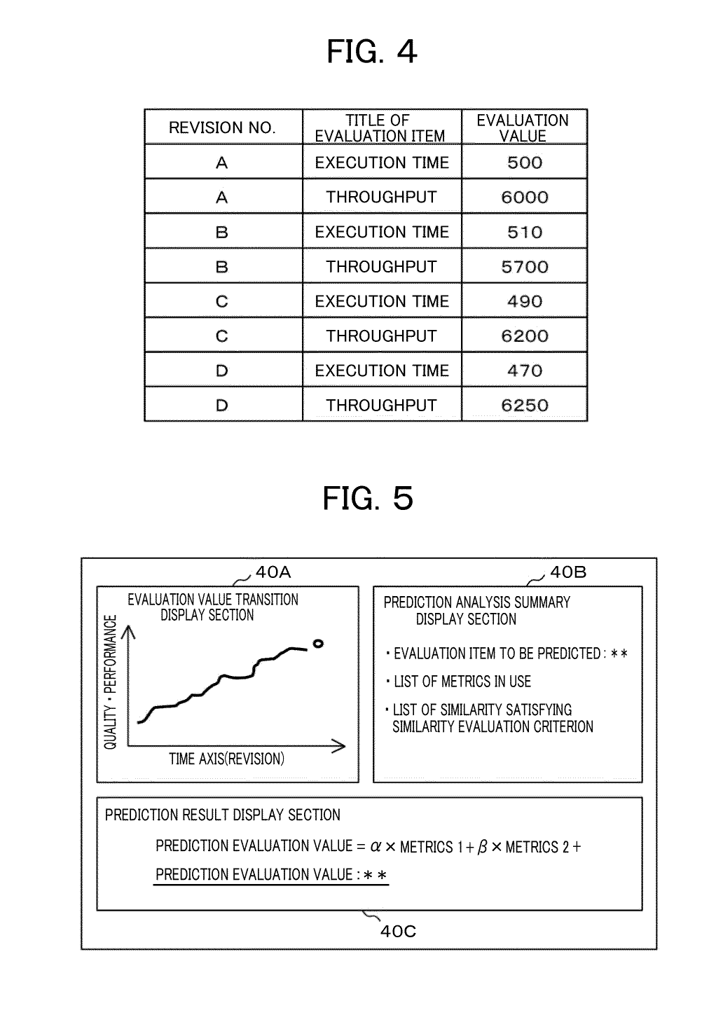

FIG. 4 is a view showing the performance evaluation table which registers the revision numbers, evaluation item names and evaluation values.

The explanation will be made referring to FIG. 1. The evaluation process execution section 2 includes a metrics registration section 201, a fluctuation pattern calculation section 202, a similarity calculation section 203, an evaluation prediction section 204, and a result output section 205. The evaluation process execution unit 2 controls the metrics registration section 201, the fluctuation pattern calculation section 202, the similarity calculation section 203, the evaluation prediction section 204, and the result output section 205, and interactions with such peripheral device as the I/O unit 4, the management server 5, and a not shown external storage unit. The evaluation process execution section 2 is executed by a CPU and a programmable device (FPGA, PLD).

The recording section 3 records a fluctuation pattern 301, a similarity 302 and an evaluation prediction model 303 as well as data input from the I/O unit 4, a driver, a database stab, and a network stab. The recording section 3 is a memory, for example, ROM, RAM, and hard disk. The recording section 3 may be used as a work area which records data, for example, variable values and parameter values for executing the respective processes of the evaluation process execution section 2 as described below.

The metrics registration section 201 acquires source codes of the respective revisions prior to the one subjected to evaluation prediction of the software under development from the repository 71, and calculates the software metrics. The calculated software metrics is stored in the development information database 81. The metrics registration section 201 stores the process metrics input from the I/O unit 4 in the development information database 81. Calculation of the software metrics may use the tool developed through the open source such as CCCC.

The fluctuation pattern calculation section 202 acquires the software metrics and the process metrics of an arbitrary revision prior to the one as the evaluation prediction target, and the immediately preceding revision of the arbitrary revision from the development information database 81, and calculates the fluctuation amount of acquired data of the software metrics and process metrics of the arbitrary revision from the immediately preceding revision as a fluctuation pattern 301. The fluctuation pattern calculation section 202 records the calculated fluctuation pattern 301 in the recording section 3.

A formula (1) expresses an example of the fluctuation pattern 301 from the revision C to the revision D as shown in FIGS. 2 and 3, which will be called the fluctuation pattern 301 of the revision D. For example, referring to the software metrics table shown in FIG. 2, the number of source code lines of the file 1 is increased from 350 of the revision C to 370 of the revision D by 20. Then complexity of the file 1 is decreased from 17 of the revision C to 15 of the revision D by 2. In the example expressed by the formula (1), the fluctuation amount is expressed by the numerical value so that the development language that is not expressed by the numerical value is not contained in the item of the fluctuation pattern 301. The fluctuation pattern 301 may be expressed by presence or absence of the change besides the fluctuation amount expressed by the numerical value. A formula (2) shows an example of the fluctuation pattern 301 for expressing presence or absence of the change. In the presence of fluctuation, the value is set to “1”, and in the absence of fluctuation, it is set to “0” so as to express the fluctuation pattern 301 from the revision C to the revision D likewise the formula (1).

Fluctuation pattern=(fluctuation amount of source code lines of file 1,

fluctuation amount of complexity of file 1,

fluctuation amount of the number of development personnel of file 1,

fluctuation amount of the skill level of the development personnel of file 1,

fluctuation amount of the source code line of file 2,

fluctuation amount of complexity of file 2,

fluctuation amount of the number of the development personnel of file 2,

fluctuation amount of skill level of the development personnel of file 2)

=(+20,−2,+1,−1,+10,+4,0,0) (1)

Fluctuation pattern=(number of source code lines of file 1,

complexity of file 1,

development language of file 1,

number of development personnel of file 1,

skill level of development personnel of file 1,

number of source code lines of file 2,

complexity of file 2,

development language of file 2,

number of development personnel of file 2,

skill level of development personnel of file 2)

=(1,1,0,1,1,1,1,0,0,0) (2)

The similarity calculation section 203 calculates the similarity 302 of the fluctuation pattern 301 between the revision as the evaluation prediction target and the revision prior thereto, and records the calculated similarity 302 in the recording section 3. Regarding each of the fluctuation patterns 301 as vector, the similarity 302 is expressed as the distance between the vectors (Euclidean distance, Mahalanobis distance).

The evaluation prediction section 204 generates the evaluation prediction model 303 for calculating the evaluation prediction value of the revision as the evaluation prediction target, and records the generated evaluation prediction model 303 in the recording section 3. The evaluation prediction section 204 calculates the evaluation prediction value of the revision as the evaluation prediction target using the evaluation prediction model 303 recorded in the recording section 3. The result output section 205 outputs the result to the I/O unit 4.

FIG. 5 is a view showing an example of a display screen displaying output of the result output section 205 to the I/O unit 4. The display screen includes an evaluation value transition display section 40A, a prediction analysis summary display section 40B, and a prediction result display section 40C. The evaluation value transition display section 40A displays transition of the evaluation value of the evaluation item to be predicted with time. The prediction analysis summary display section 40B displays the summary including setting of the evaluation prediction. The prediction result display section 40C displays the evaluation prediction model 303 generated by the evaluation prediction section 204, and the evaluation prediction value calculated using the evaluation prediction model 303. The display screen illustrated in FIG. 5 only shows an example, which may be configured to display only a part of the display as described above.

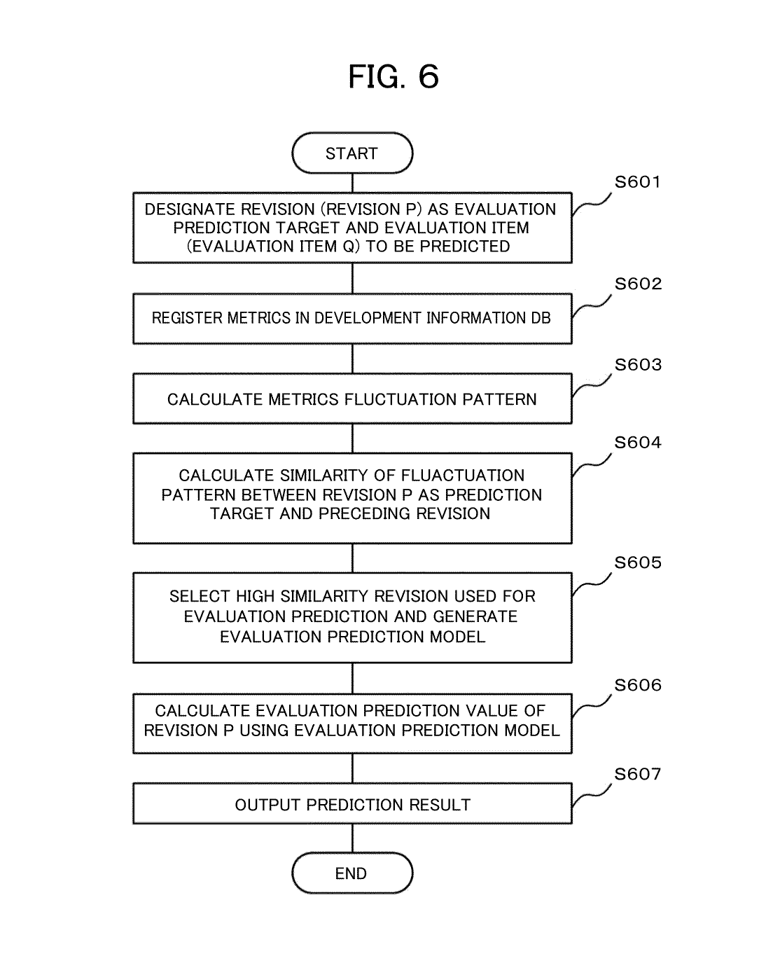

An operation of the software evaluation device 1 will be described. FIG. 6 is a flowchart representing an example of the process performed by the evaluation process execution section 2.

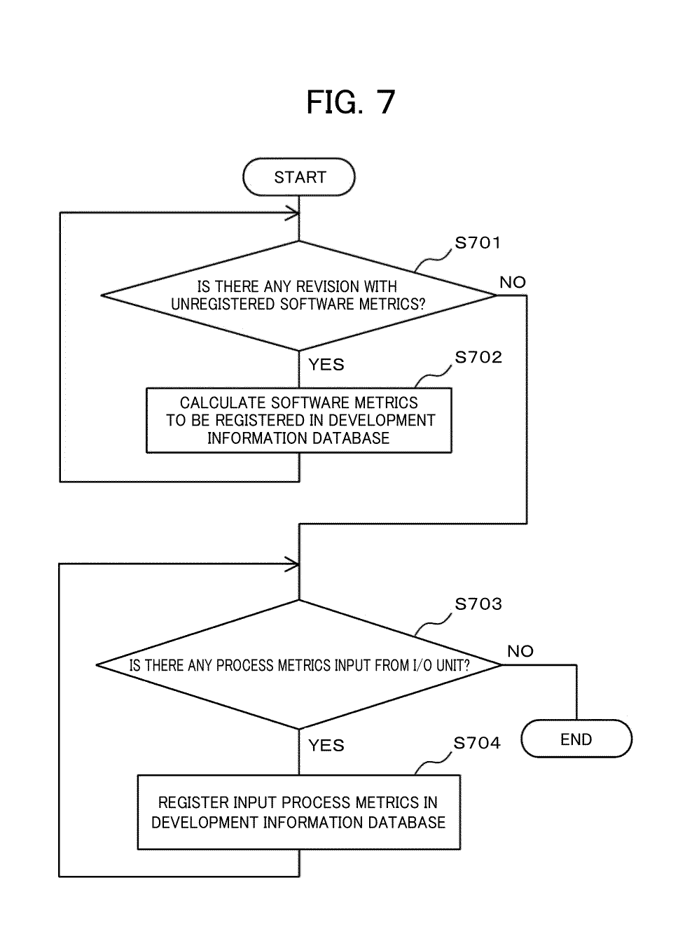

The evaluation process execution section 2 designates a revision P as the evaluation prediction target of the software under development, and an evaluation item Q to be predicted (S601). The evaluation process execution section 2 registers the software metrics and the process metrics with respect to the revision prior to the revision P in the development information database 81 (S602). The process step S602 will be described in detail referring to the metrics registration flow as shown in FIG. 7.

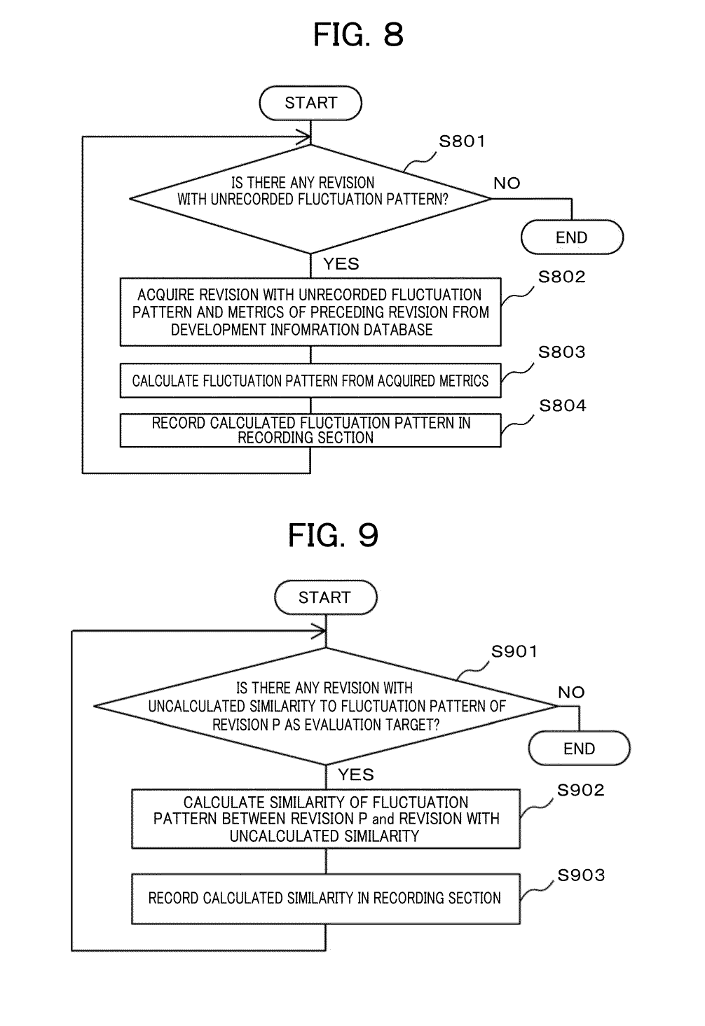

The evaluation process execution section 2 acquires the software metrics and the process metrics with respect to an arbitrary revision and the immediately preceding revision thereof among those prior to the revision P from the development information database 81, and calculates the fluctuation pattern 301 of the software metrics and the process metrics (S603). The process step S603 will be described in detail referring to the fluctuation pattern calculation flow as shown in FIG. 8. The evaluation process execution section 2 calculates the similarity 302 of the fluctuation pattern between the revision P and the arbitrary revision prior to the revision P (S604). The process step S604 will be described in detail referring to the similarity calculation flow as shown in FIG. 9.

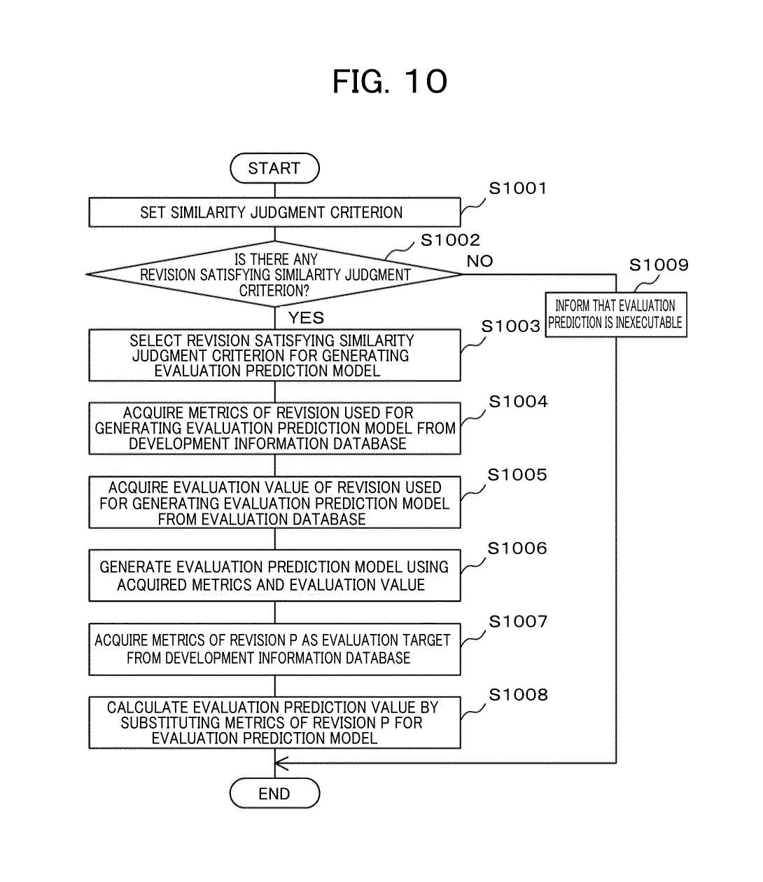

The evaluation process execution section 2 selects the past revision with high (close resemblance) similarity 302 calculated in S604 for generating the evaluation prediction model 303, and generates the evaluation prediction model 303 using the selected revision information (S605). The evaluation process execution section 2 calculates the evaluation prediction value using the generated evaluation prediction model 303 (S606). The process steps S605 and 606 will be described in detail referring to the evaluation prediction flow as shown in FIG. 10.

The evaluation prediction result is output (S607), and the process ends.

FIG. 7 represents an example of a flow of the process performed by the metrics registration section 201. This flow represents detailed process steps of S602 as described above referring to FIG. 6.

The metrics registration section 201 determines whether there is any of revisions prior to the revision P as the evaluation prediction target, which has the software metrics unregistered in the development information database 81 (S701). If there is the revision with unregistered software metrics, the process proceeds to S702. It there is not, the process proceeds to S703. The metrics registration section 201 calculates the software metrics with respect to the revision with the unregistered software metrics, and registers the calculated software metrics in the development information database 81 (S702).

The metrics registration section 201 determines whether there is the process metrics input from the I/O unit 4 (S703). If there is the input process metrics, the process proceeds to S704. If there is not, the process ends. The process metrics input from the I/O unit 4 is registered in the development information database 81 (S704), and then the process ends. In this flow, the software metrics is registered firstly. However, it is also possible to firstly register the process metrics.

FIG. 8 represents an example of a flow of the process performed by the fluctuation pattern calculation section 202. This flow represents detailed process steps of S603 as described above referring to FIG. 6.

The fluctuation pattern calculation section 202 determines whether there is an arbitrary revision among those prior to the revision P as the evaluation prediction target, which has the fluctuation pattern 301 unrecorded in the recording section 3 (S801). If there is the revision with the unrecorded fluctuation pattern 301, the process proceeds to S802. If there is not, the process ends.

The fluctuation pattern calculation section 202 acquires the software metrics and the process metrics of the revision with the unrecorded fluctuation pattern 301 and the immediately preceding revision thereof from the development information database 81 (S802). The fluctuation pattern calculation section 202 calculates the fluctuation pattern 301 from the software metrics and the process metrics acquired in S802 (S803). The fluctuation pattern calculation section 202 records the fluctuation pattern 301 calculated in S803 in the recording section 3 (S804).

FIG. 9 represents an example of a flow of the process performed by the similarity calculation section 203. This flow represents detailed process steps of S604 as described above referring to FIG. 6.

The similarity calculation section 203 determines whether there is any of the revisions with no calculated similarity 302 of the fluctuation pattern 301 recorded in the recording section 3 to the fluctuation pattern 301 of the revision P (S901). If there is the revision with no calculated similarity 302, the process proceeds to S902. If there is not, the process ends.

The similarity calculation section 203 calculates the similarity 302 of the fluctuation pattern 301 between the revision P and the revision with no calculated similarity 302 to that of the revision P (S902). The similarity calculation section 203 records the similarity 302 calculated in S902 in the recording section 3 (S903).

FIG. 10 represents an example of a flow of the process performed by the evaluation prediction section 204. This flow represents detailed process steps of S605 and S606 as described above referring to FIG. 6.

The evaluation prediction section 204 sets a similarity judgment criterion (S1001). The minimum value of the similarity 302 employed as the revision for generating the evaluation prediction model 303 is designated as the similarity judgment criterion. In other words, the revision with the similarity 302 smaller than the minimum value is not used for generating the evaluation prediction model 303. Alternatively, it is possible to designate the number of revisions used for generating the evaluation prediction model 303 so that the designated number of the revisions satisfy the similarity judgment criterion in order from the one with the higher similarity 302. It is also possible to allow the development personnel to designate the similarity judgment criterion, or to set such criterion as default of the system.

The evaluation prediction unit 204 determines whether there is the revision which satisfies the designated similarity judgment criterion (S1002). If there is the revision which satisfies the similarity judgment criterion, the process proceeds to S1003. If there is not, the process proceeds to S1009.

The evaluation prediction section 204 selects the revision which satisfies the similarity judgment criterion as the one used for generating the evaluation prediction model 303 (S1003). The evaluation prediction section 204 acquires the software metrics and the process metrics of the revision selected in S1003 from the development information database 81 (S1004). The evaluation prediction section 204 acquires the value of the prediction evaluation item Q (evaluation value) of the revision selected in S1003 from the evaluation database 91 (S1005). The values (evaluation values) of the prediction evaluation items Q of the revisions prior to the revision P as the evaluation prediction target are stored in the evaluation database 91 upon action of the evaluation prediction section 204 on the subject revision as the evaluation prediction target.

The evaluation prediction section 204 generates the evaluation prediction model 303 using the metrics acquired in S1004 and the evaluation value acquired in S1005 (S1006). The evaluation prediction model 303 is generated using the metrics acquired in S1004 as the explanatory variable, and regression analysis by taking the evaluation value acquired in S1005 as the objective variable.

The evaluation prediction section 204 acquires the software metrics and the process metrics of the revision P as the evaluation target from the development information database 81 (S1007). The evaluation prediction section 204 calculates the prediction value of the evaluation item Q of the revision P by substituting the metrics acquired in S1007 for the evaluation prediction model 303 generated in S1006 (S1008), and stores the calculated prediction value (evaluation value) of the evaluation item Q of the revision P in the evaluation database 91. The process then ends. If the value is smaller than the preliminarily designated evaluation prediction value, the notice is output (not shown) to the I/O unit 4.

Meanwhile, if there is no revision that satisfies the similarity judgment criterion in S1002, the evaluation prediction section 204 outputs the notice to the I/O unit 4, informing that the evaluation prediction model 303 cannot be generated in accordance with the designated similarity judgment criterion, that is, evaluation prediction is inexecutable (S1009). The process then ends.

### Second Embodiment

The first embodiment is configured on the assumption that there is no missing part in various metrics data required for the fluctuation pattern calculation section 202 to calculate the fluctuation pattern. This embodiment will be described as being configured to complement the missing part, if any, in the various metrics data.

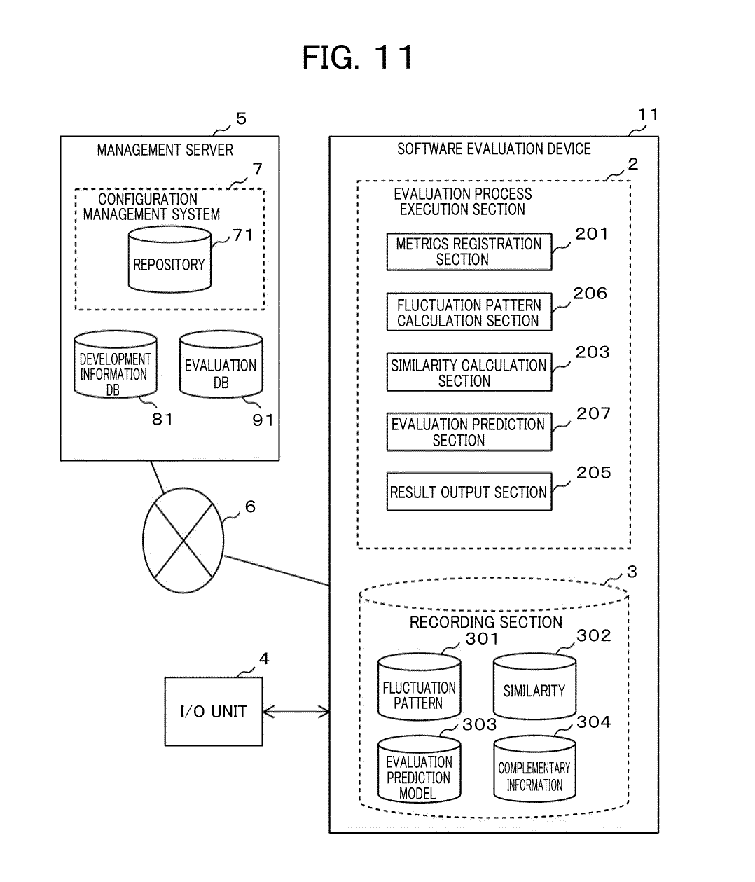

FIG. 11 is a view showing a structure of a software evaluation device 11 for executing the software evaluation program according to the embodiment. The software evaluation device 11 is different from the one as described in the first embodiment in that a fluctuation pattern calculation section 206 is employed instead of the fluctuation pattern calculation section 202, and an evaluation prediction section 207 is employed instead of the evaluation prediction section 204 for recording complementary information 304 in the recording section 3. Explanations with respect to structures designated with the same codes and the part with the same function as those described in the first embodiment will be omitted.

If there is a missing value in the metrics used for evaluation prediction of the software under development, the fluctuation pattern calculation section 206 complements the missing value, and records the value in the recording section 3 as the complementary information 304. If the missing value cannot be complemented, the fluctuation pattern calculation section 206 outputs the notice to the I/O unit 4. Then the fluctuation pattern calculation section 206 acquires the software metrics and the process metrics with respect to the arbitrary revision and the immediately preceding revision thereof among those prior to the one as the evaluation prediction target of the software under development from the development information database 81. If the complementary information 304 is recorded, it is acquired from the recording section 3. The fluctuation pattern calculation section 206 calculates the fluctuation amount of the software metrics and the process metrics of the acquired revision from those of the immediately preceding revision as the fluctuation pattern 301. The fluctuation pattern calculation section 206 records the calculated fluctuation pattern 301 in the recording section 3.

The evaluation prediction section 207 generates the evaluation prediction model 303 for calculating the evaluation prediction value of the revision as the evaluation prediction target, and records the generated evaluation prediction model 303 in the recording section 3. The evaluation prediction section 207 calculates the evaluation prediction value of the revision to be evaluation predicted using the evaluation prediction model 303 recorded in the recording section 3. Upon generation of the evaluation prediction model 303, the evaluation prediction section 207 acquires the software metrics and the process metrics of the revision used for generating the evaluation prediction model 303 from the development information database 81, and further acquires the complementary information 304, if any, from the recording section 3.

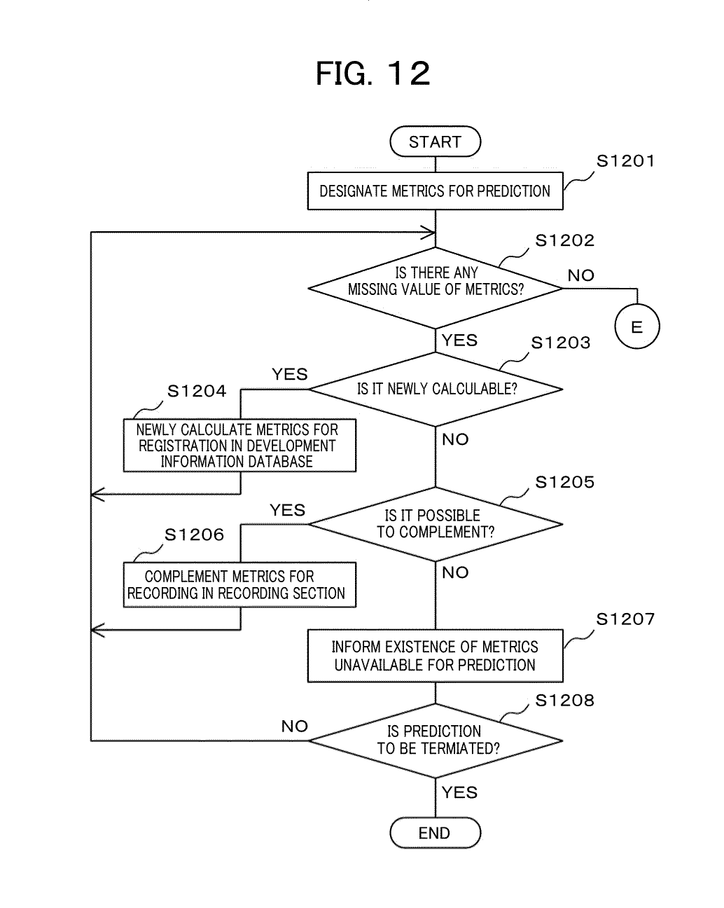

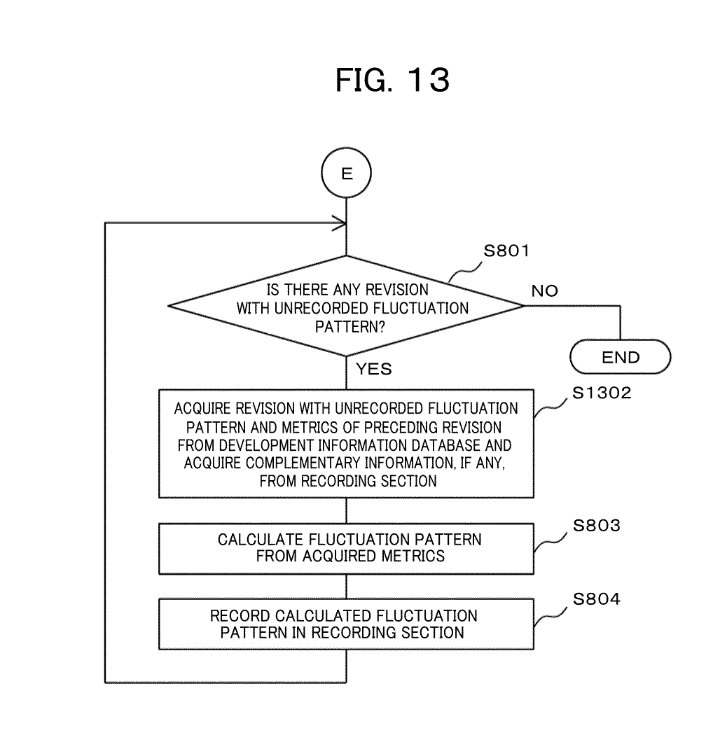

FIGS. 12 and 13 represent an example of the flow of the process performed by the fluctuation pattern calculation section 206 of the embodiment. The same process steps as those shown in FIG. 8 according to the first embodiment will be designated with the same codes, and overlapped explanations thereof, thus will be omitted.

The fluctuation pattern calculation section 206 designates the metrics used for prediction from those stored in the development information database 81 (S1201). The fluctuation pattern calculation section 206 determines whether there is the missing value in the metrics value designated in S1201 (S1202). In this embodiment, besides the missing value owing to the measurement failure, the case where no metrics value exists in the past revision of the software under development in the presence of newly added file may be regarded as the missing value. If there is the missing value, the process proceeds to S1203. If there is not, the process proceeds to S801.

The fluctuation pattern calculation section 206 determines whether it is possible to newly calculate the metrics with respect to the arbitrary missing value (S1203). For example, the number of source code lines of the newly added file may be counted, and accordingly, it is possible to newly calculate the metrics. If the new calculation of the metrics value is executable by the fluctuation pattern calculation section 206, such value is calculated (S1204). If the calculation is not executable, the process proceeds to S1205.

The fluctuation pattern calculation section 206 determines whether the metrics value can be complemented with respect to the missing value determined in S1203 to have the calculation inexecutable (S1205). If the complement is executable, the process proceeds to S1206. If the complement is not executable, the process proceeds to S1207.

The fluctuation pattern calculation section 206 complements the missing value of the metrics determined to have the complement executable in S1205, and records the complementary information 304 in the recording section 3 (S1206). For example, if the new file is added to increase the metrics types, and there is no metrics of the file added to the past revision, the resultant value is considered as “zero” for complementing. Alternatively, the mean value of the past revision is used for complementing. However, the complementary method is not limited to those described above.

The fluctuation pattern calculation section 206 outputs the notice to the I/O unit 4 informing that the metrics with the missing value, which has been determined inexecutable for complementing in S1205 is not available for the evaluation prediction of the software under development (S1207).

Based on the instruction of the operator through the I/O unit 4 in response to the notice informing the metrics unavailable for prediction, the fluctuation pattern calculation section 206 determines whether the prediction is to be continued (S1208). If the prediction is to be terminated, the process ends.

If the metrics has no missing value in S1202, the fluctuation pattern calculation section 206 acquires the software metrics and the process metrics of the revision having the fluctuation pattern 301 unrecorded and the immediately preceding revision thereof from the development information database 81 through 5801 as shown in FIG. 13. The complementary information 304 recorded in the recording section 3, if any, is acquired (S1302), and the fluctuation pattern is calculated.

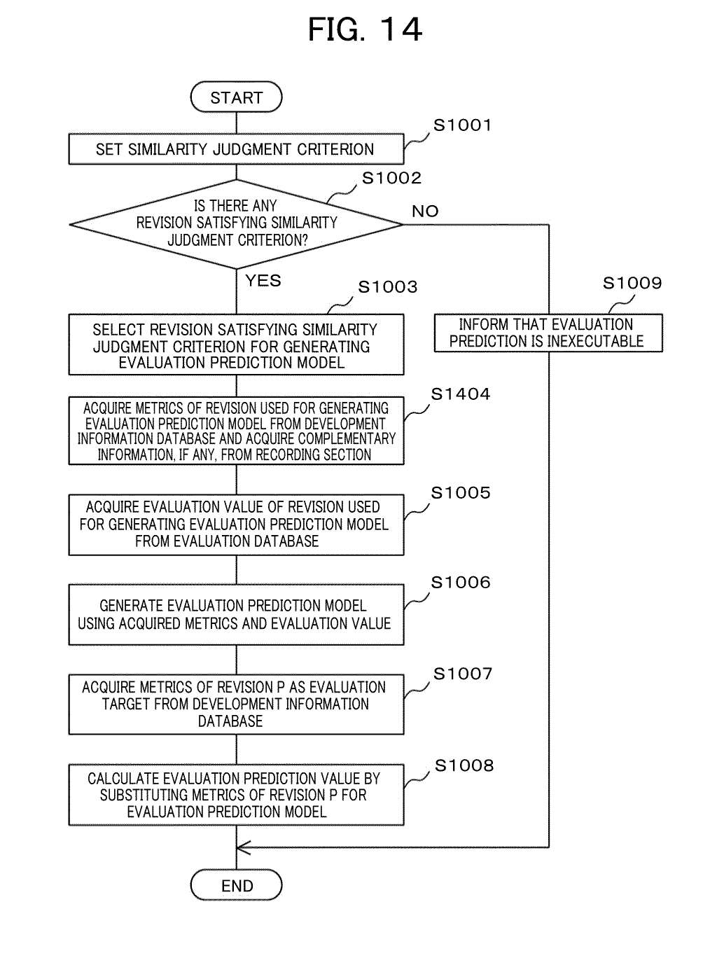

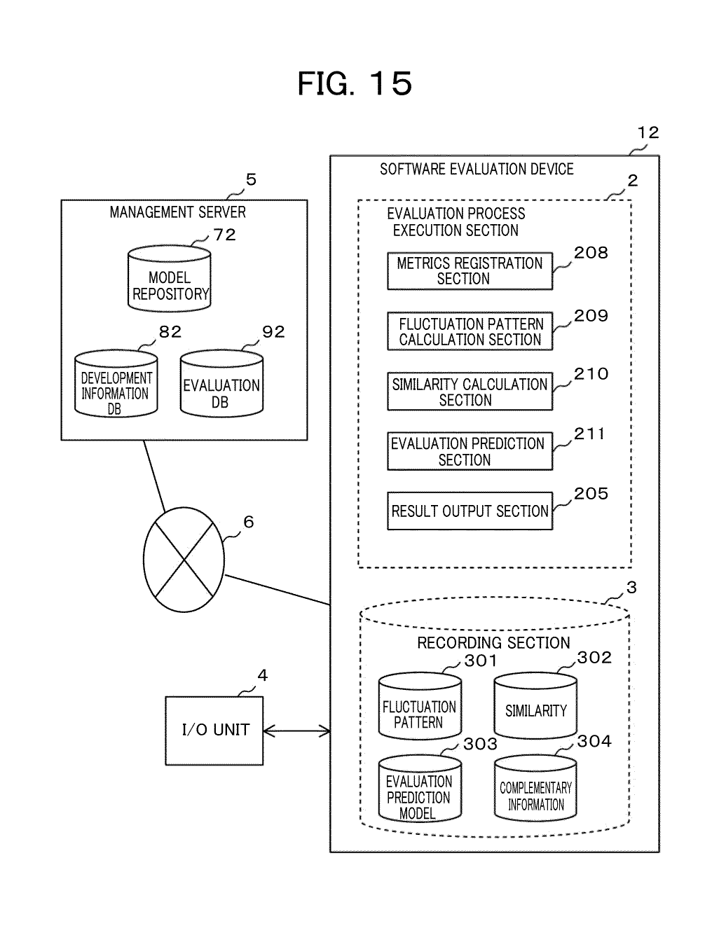

FIG. 14 represents an example of a flow of the process performed by the evaluation prediction section 207 of the embodiment. The same process steps as those of the first embodiment shown in FIG. 10 will be designated with the same codes, and overlapped explanations thereof, thus will be omitted. The flow shown in FIG. 14 includes the process performed in S1404 instead of S1004 as shown in FIG. 10.

The evaluation prediction section 207 acquires the software metrics and the process metrics of the revision selected in S1003 from the development information database 81. The complementary information 304 recorded in the recording section 3, if any, is acquired (S1404).

According to the embodiment, even if the metrics value used for the evaluation prediction is not registered in the database, evaluation of the software under development is ensured by complementing.

### Third Embodiment

The first and the second embodiments use the software metrics calculated from the source codes stored in the repository 71 of the configuration management system 7. This embodiment uses the software metrics calculated from the model information stored in the model repository 72 without providing the configuration management system 7. This embodiment uses the fluctuation amount from the arbitrary revision prior to the target revision rather than the one from the immediately preceding revision for calculating the fluctuation pattern 301 in this embodiment.

FIG. 15 is a view showing a structure of a software evaluation device which executes the software evaluation program according to this embodiment. A software evaluation device 12 is different from the one according to the second embodiment in the use of a metrics registration section 208, a fluctuation pattern calculation section 209, a similarity calculation section 210, and an evaluation prediction section 211 instead of the metrics registration section 201, the fluctuation pattern calculation section 206, the similarity calculation section 203, and the evaluation prediction section 207 of the second embodiment, and a model repository 72, a development information database 82 and an evaluation database 92 in the management server 5. Explanations of structures designated with the same codes and the part with the same function as those described in the second embodiment will be omitted.

The management server 5 includes the model repository 72 which manages the design model of the software under development, the development information database 82 which stores the software development information, and the evaluation database 92 which stores the software evaluation value. The model repository 72 is capable of storing information of the model designed using UML (Unified Modeling Language) and MATLAB (MATrix LABoratory) in XMI (XML Metadata Interchange) form or unique text form. The model repository 72 according to this embodiment does not use the configuration management system. However, the configuration management system capable of storing the model information may be used. The development information database 82 includes the software metrics table which contains the software metrics. The evaluation database 92 includes the quality evaluation table. The table included in the development information database 82 may be configured to contain the process metrics table similar to that of the first or the second embodiment besides the software metrics table. The evaluation database 92 may be configured to contain the performance evaluation table instead of the quality evaluation table, or contain both the quality evaluation table and the performance evaluation table.

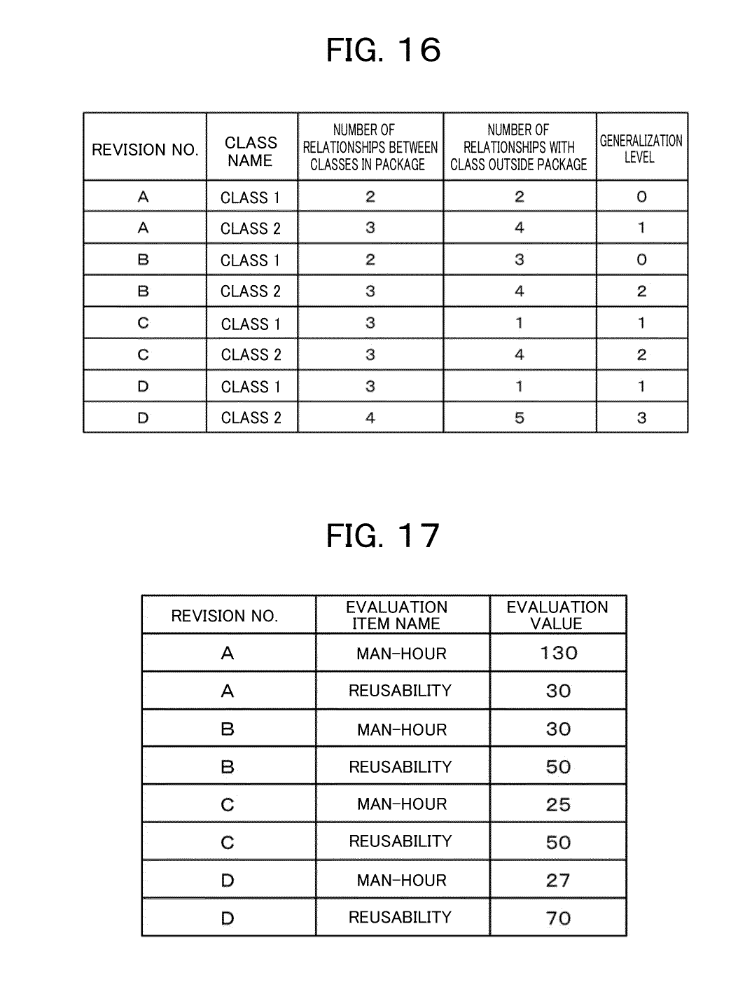

FIG. 16 is a view of the software metrics table included in the development information database 82. The software metric table registers the model revision numbers of the respective revisions stored in the model repository 72, the class names, the number of relationships between the class represented by the class name and the other class in the package, the number of relationships between the class represented by the class name and the other class outside the package, and generalization level of the class represented by the class name. The software metrics to be registered is capable of using the arbitrary metrics that can be calculated from the design model besides the one as described above. Alternatively, the statistics obtained through calculation may be used.

FIG. 17 is a view of the quality evaluation table included in the evaluation database 92. The quality evaluation table registers the revision numbers, evaluation item names and evaluation values. The quality evaluation table is different from the performance evaluation table in that the evaluation item represented by the evaluation item name relates to quality such as man-hours and reusability rather than performance.

The explanation will be made referring to FIG. 15. If there is the missing value in the metrics used for the evaluation prediction, the fluctuation pattern calculation section 209 complements the missing value so as to be recorded in the recording section 3 as the complementary information 304. If the missing value cannot be complemented, the fluctuation pattern calculation section 209 outputs the notice to the I/O unit 4 informing that the complement is inexecutable. The fluctuation pattern calculation section 209 acquires the software metrics with respect to an arbitrary “revision combination” prior to the revision as the evaluation prediction target from the development information database 82, and further acquires the recorded complementary information 304, if any, from the recording section 3. The fluctuation pattern calculation section 209 calculates the fluctuation amount from the acquired software metrics of the revision as the fluctuation pattern 301. The calculated fluctuation pattern 301 is recorded in the recording section 3.

The evaluation prediction section 211 generates the evaluation prediction model 303 for calculating the evaluation prediction value of the revision as the evaluation prediction target, and records the generated evaluation prediction model 303 in the recording section 3. The evaluation prediction section 211 uses the evaluation prediction model 303 recorded in the recording section 3 to calculate the evaluation prediction value of the revision as the evaluation prediction target. The evaluation prediction section 211 acquires the software metrics of the revision used for generating the evaluation prediction model 303 from the development information database 82, and further acquires the complementary information 304, if any, from the recording section 3.

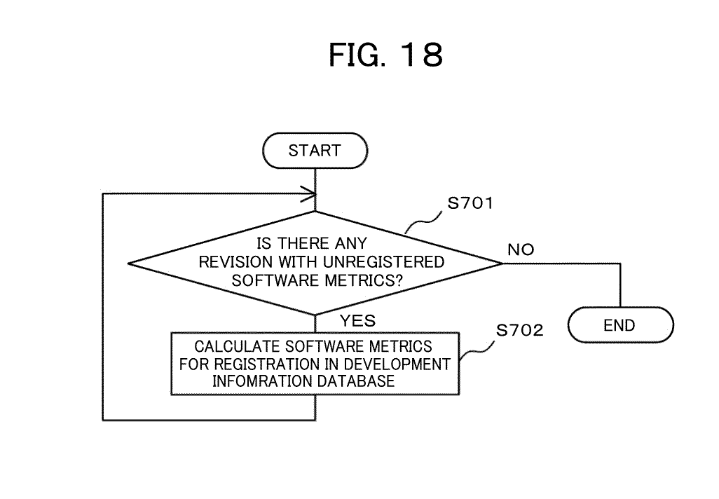

FIG. 18 is a view representing an example of the flow of the process performed by the metrics registration section 208 according to the embodiment. FIG. 18 is different from FIG. 7 in that the process steps concerning the process metrics shown in FIG. 7 (S703, S704) are omitted. The process steps S701 and S702 are the same as those shown in FIG. 7, and explanations thereof, thus will be omitted.

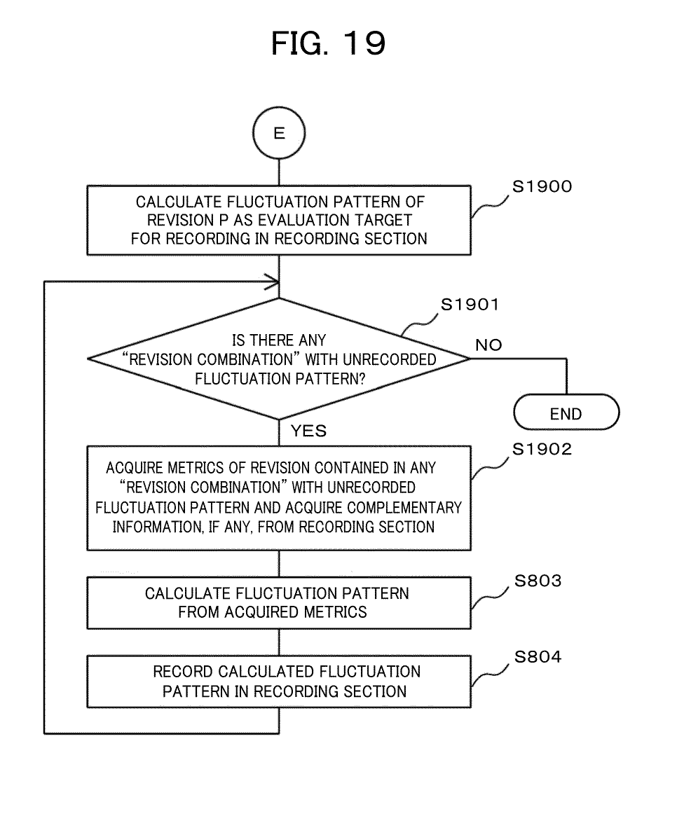

FIG. 19 represents a latter half of the flow of the process performed by the fluctuation pattern calculation section 209 according to the embodiment (corresponding to FIG. 13). The same process steps as those described in the second embodiment referring to FIG. 13 will be designated with the same codes, and overlapped explanations will be omitted. The first half of the flow of the process performed by the fluctuation pattern calculation section 209 according to the embodiment is the same as the one described in the second embodiment referring to FIG. 12.

The fluctuation pattern calculation section 209 designates the revision R prior to the revision P as the evaluation target, and acquires the software metrics of the revisions P and R from the development information database 82. The complementary information 304 of the revisions P and R recorded in the recording section 3, if any, is acquired. The fluctuation pattern 301 of the revision P is calculated from the acquired software metrics and the complementary information 304 (S1900).

The fluctuation pattern calculation section 209 determines whether there is the “revision combination” with the fluctuation pattern 301 unrecorded in the recording section 3 with respect to the arbitrary revision prior to the revision P (S1901). The revision combination denotes the combination of the arbitrary revision prior to the revision P, and the revision preceding the arbitrary revision. If there is the “revision combination” with the unrecorded fluctuation pattern 301, the process proceeds to step S1902. If there is not, the process ends.

The fluctuation pattern calculation section 209 acquires the software metrics of the revision contained in the “revision combination” with unrecorded fluctuation pattern 301 from the development information database 82, and further acquires the complementary information 304 of the revision, if any, recorded in the recording section 3 (S1902).

In the flow of the process performed by the fluctuation pattern calculation section 209 according to the embodiment as shown in FIG. 19, the fluctuation patterns 301 are calculated for all the “revision combinations”. It is possible to calculate the fluctuation pattern 301 of the arbitrary revision with unrecorded fluctuation pattern 301 with respect to the revision immediately preceding the arbitrary revision, and further calculate the fluctuation pattern 301 repeatedly toward the past revisions sequentially. Calculation of the fluctuation pattern 301 with respect to the arbitrary revision may be terminated at the time point when the fluctuation amount between the revisions exceeds the preliminarily set fluctuation amount. In this case, the fluctuation amount of the fluctuation pattern 301 of the revision P as the evaluation target may be used as the preliminarily designated fluctuation amount.

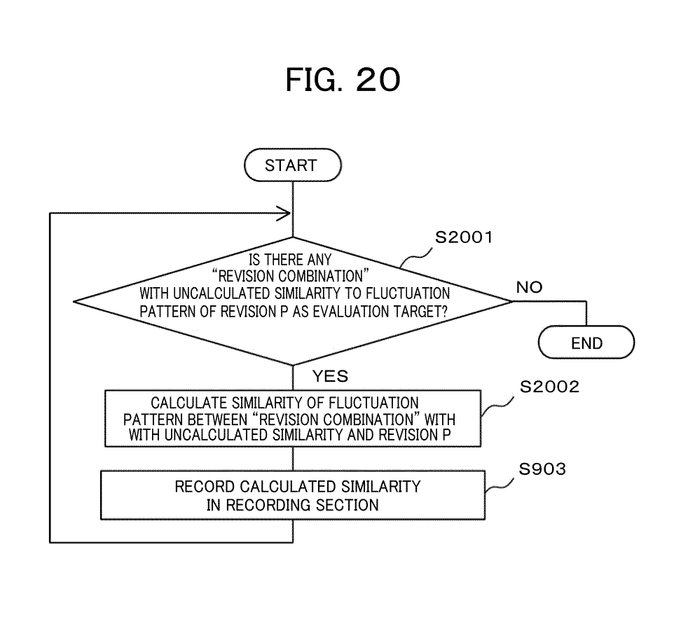

FIG. 20 is a view representing a flow of the process performed by the similarity calculation section 210 according to the embodiment. The process steps which are the same as those described in the first embodiment referring to FIG. 9 are designated with the same codes, and overlapped explanations, thus, will be omitted.

The similarity calculation section 210 determines whether there is the “revision combination” with no calculated similarity 302 between the fluctuation pattern 301 recorded in the recording section 3 and the fluctuation pattern 301 of the revision P as the evaluation target (S2001). If there is the “revision combination” with no calculated similarity 302, the process proceeds to step S2002. If there is not the “revision combination”, the process ends.

The similarity calculation section 210 calculates the similarity 302 of the fluctuation pattern 301 with respect to the arbitrary “revision combination” with no calculated similarity 302 to the fluctuation pattern 301 of the revision P (S2002).

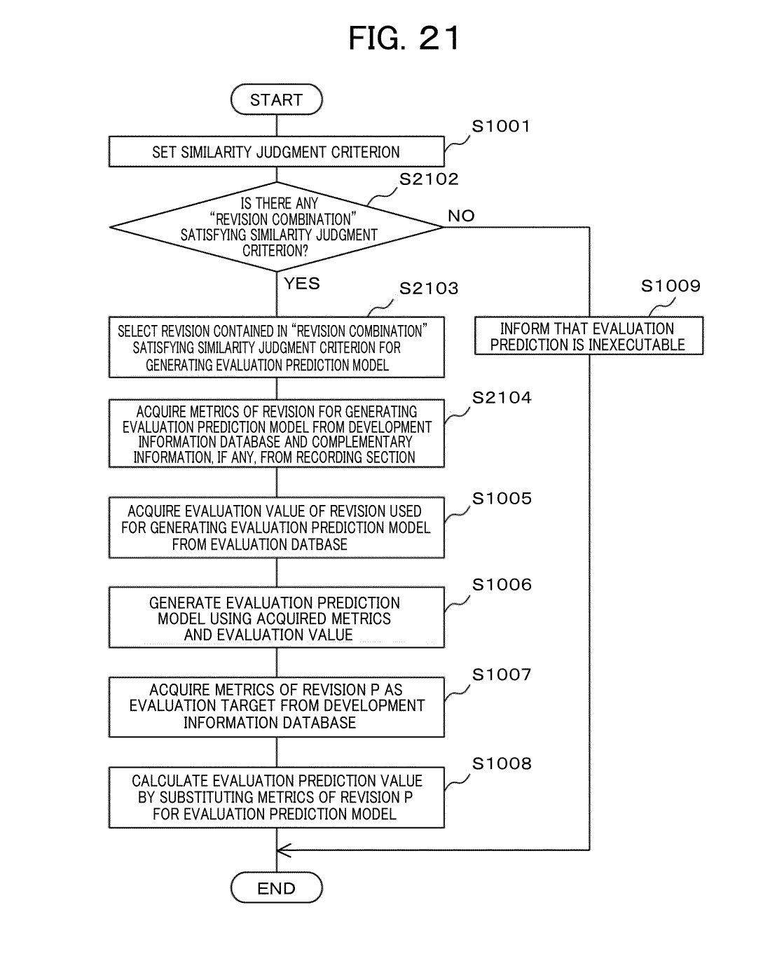

FIG. 21 is a view representing an example of the flow of the process performed by the evaluation prediction section 211 according to the embodiment. The same process steps as those described in the second embodiment referring to FIG. 14 will be designated with the same codes, and overlapped explanations, thus, will be omitted.

The evaluation prediction section 211 determines whether there is the “revision combination” with the fluctuation pattern of the revision P satisfying the set similarity judgment criterion (S2102). If there is the “revision combination” which satisfies the similarity judgment criterion, the process proceeds to S2103. If there is not, the process proceeds to S1009.

The evaluation prediction section 211 selects all the revisions included in the “revision combination” satisfying the similarity judgment criterion as those used for generating the evaluation prediction model 303 (S2103).

The evaluation prediction section 211 acquires the software metrics of the revision selected in S2103 from the development information database 82, and further acquires the complementary information 304, if any, recorded in the recording section 3 (S2104).

The evaluation prediction section 211 is configured (not shown) to output the notice to the I/O unit if the evaluation prediction value is deteriorated compared with that of the revision immediately preceding the one under development, and it is below the preliminarily designated evaluation prediction value.

According to the embodiment, even if the fluctuation amount from the immediately preceding revision is small, the fluctuation pattern 301 with respect to the arbitrary revision prior to the one as the evaluation prediction target may be designated to ensure evaluation of the software under development. Use of the metrics which can be calculated from the design model before implementation allows evaluation of the software at earlier development stage before implementation.

### Fourth Embodiment

The third embodiment uses the information of the software under development as the evaluation target. However, if the number of revisions of the software to be evaluated is small, or the number of the revisions having fluctuation pattern 301 with high similarity 302 to that of the revision as the evaluation prediction target is small irrespective of sufficient number of revisions of the software to be evaluated, it may be difficult to generate the evaluation prediction model 303. This embodiment uses the information of the past similar project if the number of revisions for generating the evaluation prediction model 303 is insufficient.

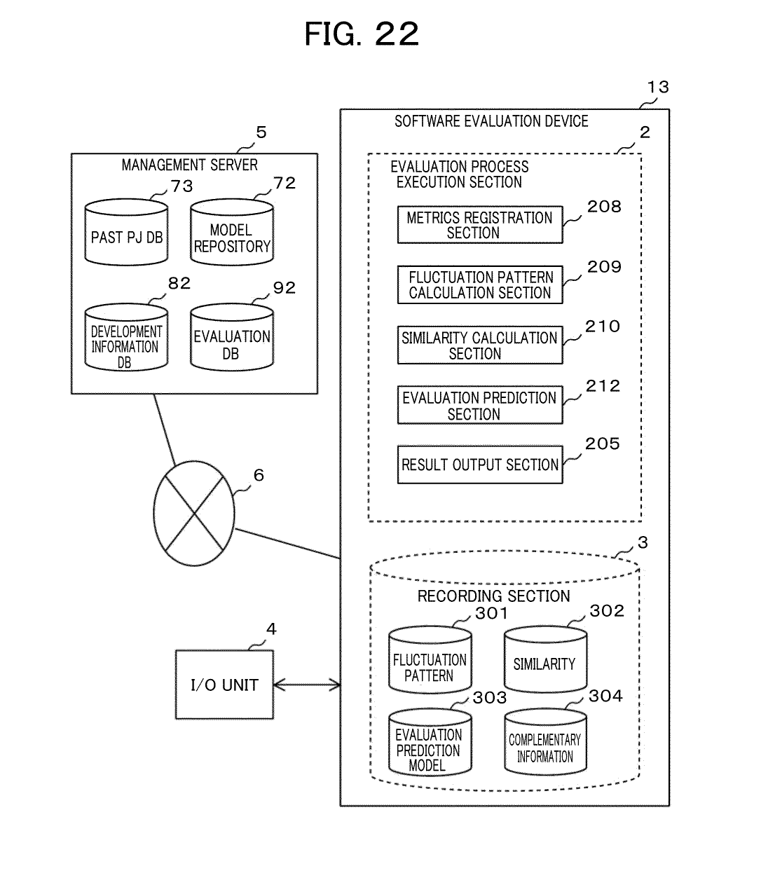

FIG. 22 is a view showing a structure of the software evaluation device which executes the software evaluation program according to the embodiment. A software evaluation device 13 is different from the one described in the third embodiment in that an evaluation prediction section 212 is provided instead of the evaluation prediction section 211 of the third embodiment, and a past project database 73 is further provided in the management server 5 in addition to the model repository 72, the development information database 82, and the evaluation database 92. Explanations of the structures designated with the same codes and the part with the same function as those described referring to FIG. 15 will be omitted.

The evaluation prediction section 212 generates the evaluation prediction model 303 for calculating the evaluation prediction value of the revision as the evaluation prediction target. If the number of the revisions used for generating the evaluation prediction model 303 is not sufficient, the similar pattern information is acquired from the past project database 73. The evaluation prediction model 303 is generated using the acquired information. The generated evaluation prediction model 303 is recorded in the recording section 3, and the evaluation prediction value of the revision as the evaluation prediction target is calculated using the recorded evaluation prediction model 303.

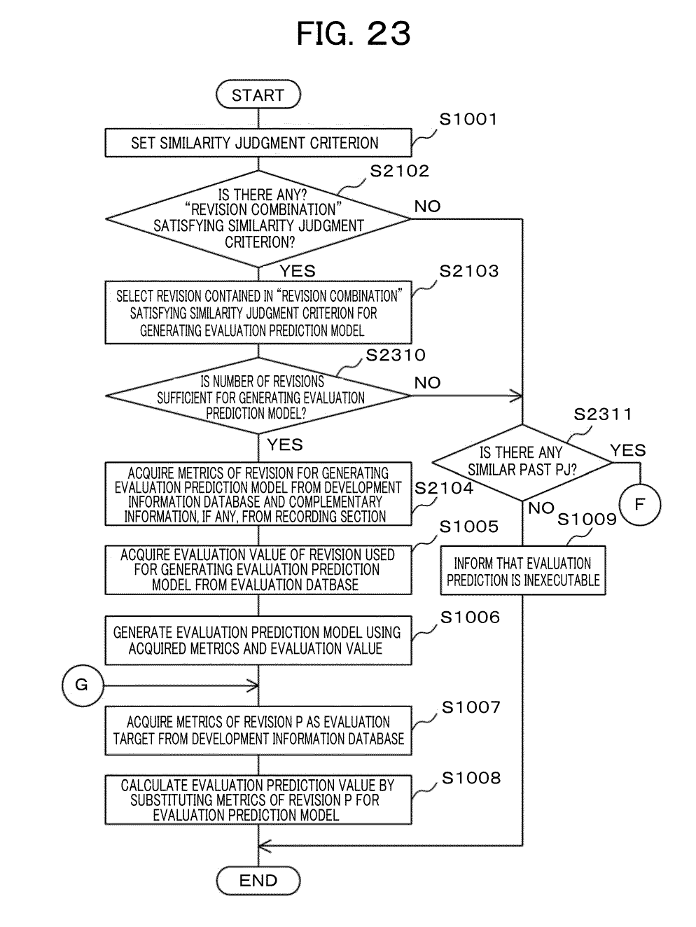

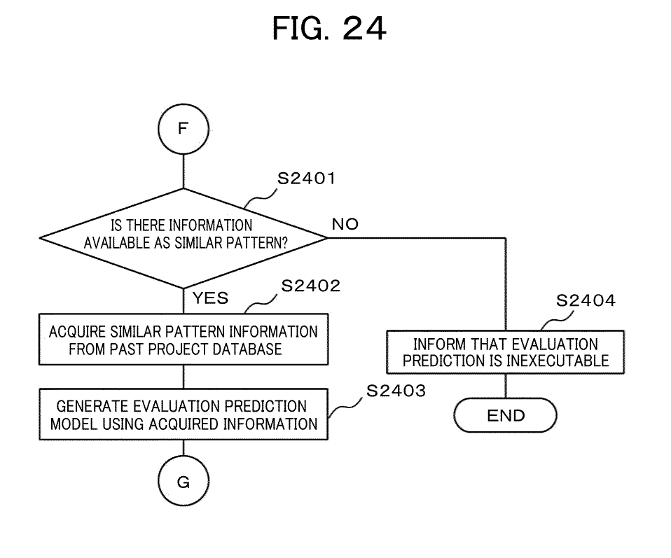

FIGS. 23 and 24 represent a flow example of the process performed by the evaluation prediction section 212 according to the embodiment. The same process steps as those described in the third embodiment referring to FIG. 21 are designated with the same codes, and overlapped explanations, thus will be omitted.

The evaluation prediction section 212 determines whether the number of revisions selected in S2103 is sufficient for generating the evaluation prediction model 303 (S2310). The number of the revisions for determination is preliminarily set. If the number is sufficient, the process proceeds to S2104. If it is not sufficient, the process proceeds to S2311.

The evaluation prediction section 212 determines whether there is any similar past project of the software to be evaluated (S2311). In this case, the “similar project” may be considered to be the project, for example, that has developed the similar system and apparatus, or the system and apparatus with the similar function. If there is the similar past project, the process proceeds to S2401. If there is not, the process proceeds to S1009.

The evaluation prediction section 212 determines whether there is the information available as the similar pattern for the past project information determined to have similarity (S2401). If there is the information, the process proceeds to S2402. If there is not, the notice is output to the I/O unit 4 informing that the evaluation prediction is inexecutable (S2404). The process then ends. For example, in the case where the metrics which represents the same meaning may be acquired from both the software to be evaluated and the past project, it may be determined that there is the information available for the similar pattern. In this case, the evaluation item value to be predicted has to be measured with respect to the corresponding past project in order to determine availability as the similar pattern.

The evaluation prediction section 212 acquires the similar pattern information determined as being available from the past project database 73 (S2402). The evaluation prediction section 212 generates the evaluation prediction model 303 using the information acquired in S2402 (S2403).

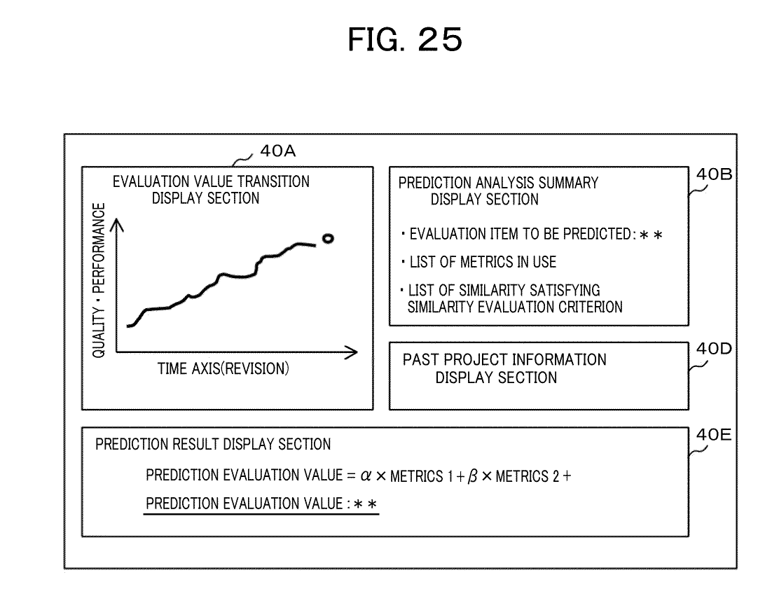

FIG. 25 represents an example of the display screen displaying output of the result output section 205 according to the embodiment to the I/O unit 4. The screen includes the evaluation value transition display section 40A, the prediction analysis summary display section 40B, a past project information 40D, and a prediction result display section 40E. Explanations of the display sections designated with the same codes as those described above referring to FIG. 5 will be omitted. If the similar past project is used for evaluation prediction by the evaluation prediction section 212, the past project information display section 40D displays the title and summary of the past project which has been used. The prediction result display section 40E displays the evaluation prediction model 303 generated by the evaluation prediction section 212 and the evaluation prediction value calculated using the evaluation prediction model 303. The display screen shown in FIG. 25 is a mere example, and it is possible to be configured to display a part of the aforementioned display.

The embodiment ensures the evaluation using the similar past project information even in the case where the development term of the software under development which is subjected to the evaluation is short, and the required number of the revisions for predicting the evaluation value is not accumulated.

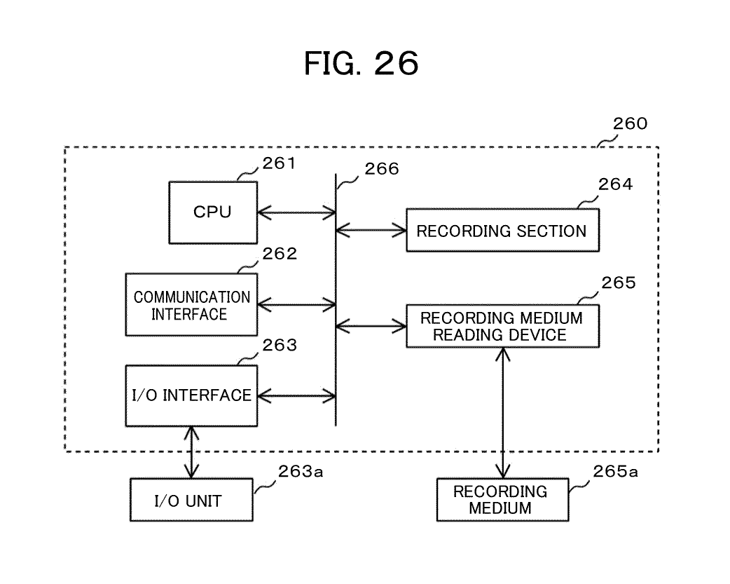

FIG. 26 shows an example of the structure of the computer which realizes the software evaluation device of the respective embodiments.

A computer 260 includes a CPU 261, a communication interface 262, an I/O interface 263, a recording section 264 (ROM, RAM, hard disk drive), and a recording medium reading device 265. The aforementioned components are connected with a bus 266, respectively.

The CPU 261 executes the respective processes of the aforementioned evaluation process execution section 2, which are stored in the recording section 264.

The communication interface 262 is an interface for LAN connection, internet connection, and wireless connection with the other computer and server as needed. It is connected to the other device for controlling input and output of data from the external device.

An I/O device 263a (I/O unit 4, mouse, keyboard, display) is connected to the I/O interface 263, which inputs the information from the I/O device 263a, and outputs the information to the CPU 261 via the bus 266. In accordance with the instruction from the CPU 261, the operation information is displayed on the screen of the I/O device 263a.

The recording section 264 records the program and data executed by the CPU 261, and is used as the work area.

The recording medium reading device 265 controls reading and writing of data with respect to a recording medium 265a under the control of the CPU 261. It records the data written in the recording medium 265a under the control of the recording medium reading device 265, and reads the data stored in the recording medium 265a. The magnetic recording device, optical disc, magneto-optical recording medium, and semiconductor memory may be used for the detachable recording medium 265a as the computer readable recording medium.

Use of the aforementioned computer executes the respective process steps as described above. In this case, the program which details the process of the function required to be installed in the system is provided. Execution of the program on the computer realizes the function required to be installed in the system on the computer. The program with written process may be recorded in the computer readable recording medium 265a.

The computer for executing the program stores the program recorded in the portable recording medium, or the program transferred from the server computer in its own storage device. The computer then reads the program from its own storage device, and executes the process in accordance with the program. The computer directly reads the program from the portable recording medium, and is allowed to execute the process in accordance with the program. For each transfer of the program from the server computer, the computer is allowed to execute the process in accordance with the received program.

The embodiment as described above allows evaluation of quality and performance of the software in the earlier development stage (under development) in the derivative or maintenance development. It is also possible to evaluate quality and performance of the software in consideration of degree of the influence on the part subjected to correction or addition.

The present invention is not limited to the embodiments as described above, and may be subjected to various improvements and modifications without deviating from the scope of the present invention. For example, the embodiments have been described in detail for the purpose of easy understanding of the present invention, which should not be limited to the one provided with all the structures as described above. It is also possible to replace a part of the structure of the embodiment with that of the other embodiment. It is also possible to have the part of the structure of the respective embodiments added to, removed from and replaced with the other structure.

The control lines and information lines are shown as they are considered to be necessary for explanations, which therefore do not necessarily represent all the control lines and information lines on the product. Actually, almost all the structures may be considered as being interconnected with one another.

1. A software evaluation device for evaluating software under development, which is connected to a development information database that registers software metrics and process metrics corresponding to a revision under development of the software and a revision developed in the past, and an I/O unit, the software evaluation device comprising:
a fluctuation pattern calculation section which calculates an amount of fluctuation of at least one of the software metrics and the process metrics of the revision under development of the software and a revision developed in the past from the revision prior to the respective revisions as a fluctuation pattern;
a similarity calculation section which calculates similarity of the fluctuation pattern between the revision of the software developed in the past and the revision under development of the software;
an evaluation prediction section which selects the revision with the high similarity among those of the software developed in the past, and generates an evaluation prediction model for predicting an evaluation prediction value of the software by using the software metrics and the process metrics of the selected revision to calculate the evaluation prediction value of the software from the generated evaluation prediction model, and at least one of the software metrics and the process metrics of the revision of the software under development; and
a result output section which displays the calculated evaluation prediction value on the I/O unit.

2. The software evaluation device according to claim 1, further comprising a metrics registration section which calculates the software metrics of the respective revisions of the software so as to be registered in the development information database, and registers the process metrics of the software input from the I/O unit in the development information database.

3. The software evaluation device according to claim 2, wherein the software metrics registered by the metrics registration section is at least one of metrics acquirable from a source code of the respective revisions of the software and metrics acquirable from a design model of the software.

4. The software evaluation device according to claim 1, wherein the fluctuation pattern calculated by the fluctuation pattern calculation section represents presence or absence of the fluctuation of at least one of the software metrics and the process metrics.

5. The software evaluation device according to claim 1, wherein the fluctuation pattern calculation section calculates an amount of fluctuation of the software metrics and the process metrics from the revision immediately preceding the respective revisions as the fluctuation pattern thereof.

6. The software evaluation device according to claim 1, wherein when a missing value exists in the software metrics and the process metrics, the fluctuation pattern calculation section complements the missing value.

7. The software evaluation device according to claim 1, wherein the result output section displays at least one item of an evaluation value transition of the revision of the software developed in the past, the similarity calculated by the similarity calculation section, the evaluation prediction model generated by the evaluation prediction section, and the calculated evaluation prediction value on the I/O unit.

8. The software evaluation device according to claim 1, wherein when the calculated evaluation prediction value is deteriorated compared with the evaluation prediction value of the revision immediately preceding the revision under development, and is below a predetermined value of the evaluation prediction value, the evaluation prediction section outputs a notice to the I/O unit.

9. The software evaluation device according to claim 1, wherein:
the software evaluation device is connected to other project database; and
when the number of revisions of the software developed in the past, which have been selected for generating the evaluation prediction model is smaller than a preliminarily set number, the evaluation prediction section uses information of the similar project stored in the other project database to generate the evaluation prediction model.

10. A software evaluation method for a software evaluation device which evaluates software under development, the software evaluation device being connected to a development information database which registers software metrics and process metrics corresponding to a revision of the software under development and a revision developed in the past, and an I/O unit, comprising the steps of:
calculating an amount of fluctuation of at least one of the software metrics and the process metrics of the revision of the software under development and the revision developed in the past from a revision prior to the respective revisions as a fluctuation pattern;
calculating similarity of the fluctuation pattern between the revisions of the software developed in the past and the revision of the software under development;
selecting the revision with the high similarity from the revisions of the software developed in the past, and generating an evaluation prediction model for predicting an evaluation prediction value of the software using the software metrics and the process metrics of the selected revision to calculate the evaluation prediction value of the software from the generated evaluation prediction model and at least one of the software metrics and the process metrics of the revision of the software under development; and
displaying the calculated evaluation prediction value on the I/O unit.

11. The software evaluation method according to claim 10, wherein the software evaluation device calculates the software metrics of the respective revisions of the software so as to be registered in the development information database, and registers the process metrics of the software input from the I/O unit in the development information database.

12. A software evaluation program which allows a computer that forms a software evaluation device for evaluating software under development, and is connected to a development information database that registers software metrics and process metrics corresponding to a revision of the software under development and a revision developed in the past, and an I/O unit to execute:
fluctuation pattern calculation process for calculating an amount of fluctuation of at least one of the software metrics and the process metrics of the revision of the software under development and the revision developed in the past from a revision prior to the respective revisions as a fluctuation pattern;
similarity calculation process for calculating similarity of the fluctuation pattern between the revision of the software developed in the past and the revision of the software under development;
evaluation prediction process for selecting the revision with the high similarity from the revisions of the software developed in the past, and generating an evaluation prediction model for predicting an evaluation prediction value of the software using the software metrics and the process metrics of the selected revision to calculate the evaluation prediction value of the software from the generated evaluation prediction model and at least one of the software metrics and the process metrics of the revision of the software under development; and
result output process for displaying the calculated evaluation prediction value on the I/O unit.

13. The software evaluation program according to claim 12, wherein the computer is allowed to further execute a metrics registration process for calculating the software metrics of the respective revisions of the software so as to be registered in the development information database, and registering the process metrics of the software input from the I/O unit in the development information database.
